(19) United States
(12) Patent Application Publication
(10) Pub. No.: US 2017/0181581 A1
(43) Pub. Date: Jun. 29, 2017

(54) Hand Protection and Means for Stabilizing Food for Preparation

(71) Applicants: Robert Waddill Batts, JR., Salisbury, MD (US); Lori Batts, Salisbury, MD (US)

(72) Inventors: Robert Waddill Batts, JR., Salisbury, MD (US); Lori Batts, Salisbury, MD (US)

(21) Appl. No.: 15/388,180

(22) Filed: Dec. 22, 2016

Related U.S. Application Data
(60) Provisional application No. 62/272,103, filed on Dec. 29, 2015.

(51) Int. Cl. A47J 43/28; A41D 13/08

(52) U.S. Cl. CPC A47J 43/283; A41D 13/087; A41D 13/084

(57) ABSTRACT

A device to aid in the stabilization and preparation of food while protecting the user's fingers.

### CROSS REFERENCE TO RELATED APPLICATIONS

This application claims priority to provisional application 62/272,103, hereby now incorporated by reference.

### FEDERALLY SPONSORED RESEARCH

Not applicable.

### NAMES OF PARTIES TO A JOINT RESEARCH AGREEMENT

Not applicable.

### INCORPORATE BY REFERENCE CD OF SEQUENCE LISTING OR PROGRAM LISTING

Not applicable.

### PRIOR DISCLOSURES BY INVENTOR OR JOINT INVENTOR

Not applicable.

### BACKGROUND

Field of the Invention

The present invention relates to hand tools for kitchen use and more particularly to hand protection while cutting and preparing food.

Background Art

Cutting oneself while preparing food is a common problem in both household and commercial kitchens alike. Gloves that are worn to help protect a chef's hands are bulky, which can reduce stabilization of the food while cutting. Additionally, they are expensive and, if damaged, are likely not to function properly or lead to a higher risk of being cut.

Additionally, solid plates that cover a user's fingers are not practical because they are still open on the bottom and sides. If the knife slips below the fingers or in between the fingers, the user is still subjected to cutting themselves.

### SUMMARY

In view of the forgoing disadvantages in the current art, your applicant has designed a device to encapsulate a user's fingers and stabilize food without the user's fingers being subjected to physical harm while preparing food.

### BRIEF DESCRIPTION OF THE DRAWINGS

FIG. 1 is a direct side view of the first embodiment with the knuckle guard clearly articulated from the top front of the embodiment, and the tines extending from the back base.

FIG. 2 is the front view of the first embodiment with the bottom of the tines extending out from the base at the back part of the embodiment.

FIG. 3 is the top view of the first embodiment displaying the attachment of the tines to the base of the embodiment and the knuckle guard protruding from the top in dashed lines.

FIG. 4 is an aerial side view while also viewing the back from an angle of the first embodiment, showing the articulation of the knuckle guard from the top, the hollow chamber inside for hand placement, and the tines extending from the base.

### DRAWINGS—REFERENCE NUMERALS

100 knuckle guard
101 sides of device
102 back of device
103 textured bottom, displayed as tines in drawings
104 interior chamber of the device

### DETAILED DESCRIPTION

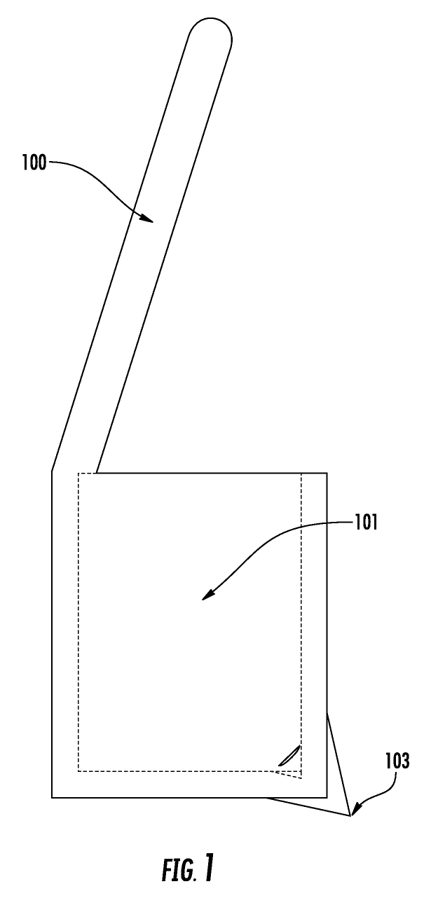

One embodiment of the present invention is shown in FIGS. 1-4. It is presently contemplated for this embodiment to be made entirely from steel. However, it could be made from other materials such as titanium, polycarbonate, etc.

FIG. 1 illustrates a side view of a preferred embodiment with the entire device being made from steel. It is presently contemplated for this embodiment that the sides 101 would uniformly measure approximately 0.5 to 1 inches and the front and back of the box uniformly measuring approximately 2 to 3 inches and the height of the entire box measuring approximately 1 inch. The box being hollow so that the user may place his or her fingers inside.

FIG. 1 further illustrates the knuckle guard 100 attached to the top of the device at an angle between 60 and 85 degrees, with 72 degrees being a preferred angle. The knuckle guard 100, in the present embodiment being fixed and not adjustable.

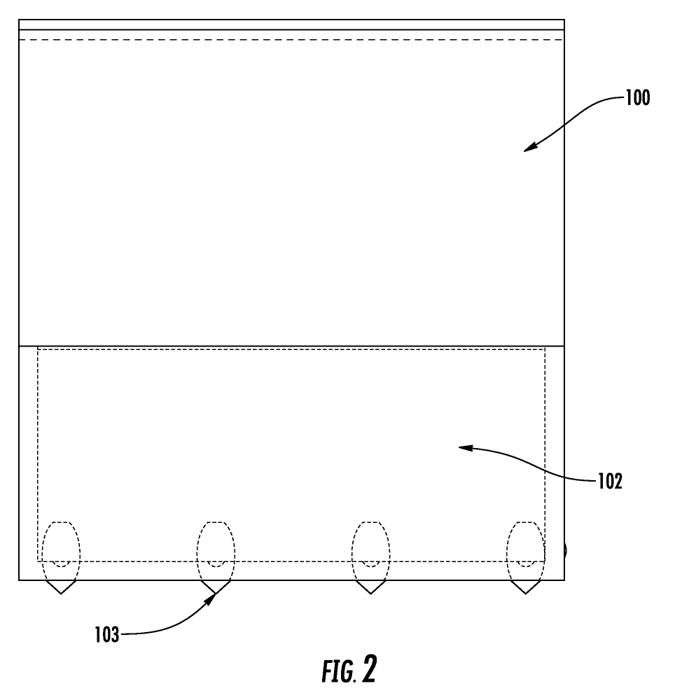

FIG. 2 illustrates a back view of the box, where the knuckle guard 100 is affixed to the top front and angled towards the back 102 of the box. FIG. 2 further illustrates a preferred embodiment with tines 103 for the purpose of stabilizing food that may be difficult to hold against a flat surface due to its shape, mainly rounded foods such as carrots and potatoes, for example. The tines 103 being fixed and not adjustable, and made from the same material as the rest of the device, preferably steel. The number of tines 103 may vary with the preferred number being 4. Additionally, other embodiments of the device may not include tines.

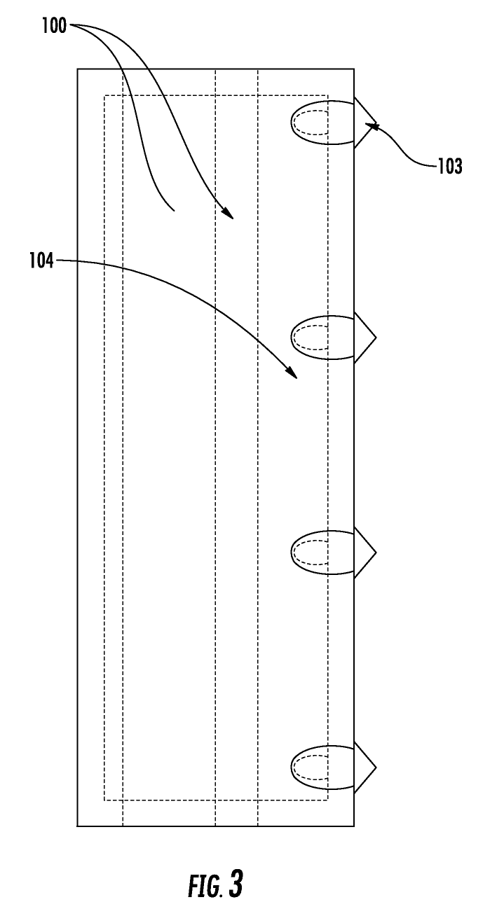

FIG. 3 is an aerial view of the device where the tines 103 are shown attached to the inside of the hollow chamber 104 and protrude through the base towards the back 102 of the box. Additionally, it is presently contemplated for this embodiment that the hollow chamber 104 would be lined with a material such as silicone or other similar material to add comfort for the user. Additional embodiments may not include such a liner.

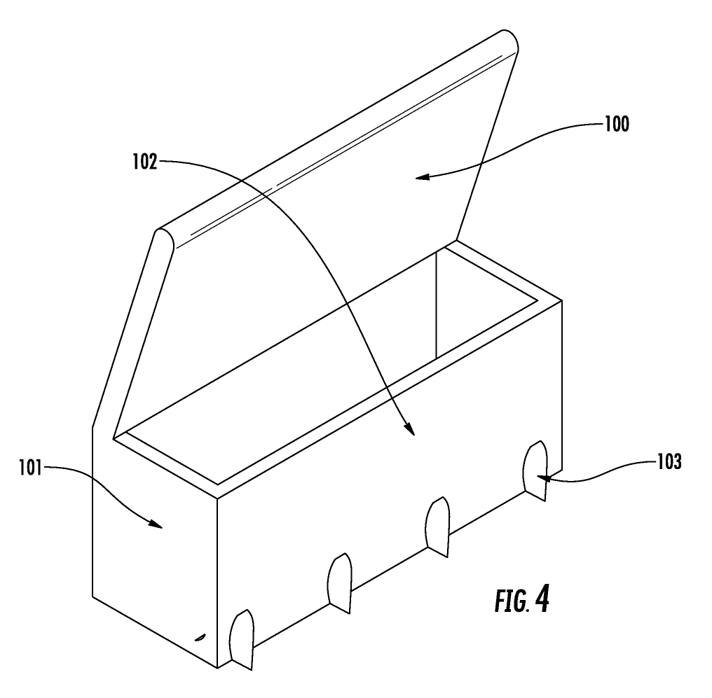

FIG. 4 is a clear depiction of the device itself from a back and side angle. The tines 103 are shown affixed to the back 102 of the device and the knuckle guard 100 affixed to the front of the device and angled towards the back. FIG. 4 should also serve to illustrate that the configuration of the device will allow use by both right and left handed users.

The manner of using the gadget consists of the user placing his or her non-dominant hand into the hollow cavity with the knuckle guard 100 coming up on the outside of the hand (opposite of the palm) to cover the user's knuckles. The user will hold the device on the food to be prepared, and if the food is unstable, use the tines 103 to pierce the food to hold it in place. The user may then chop the food without any worry of cutting him or herself.

The gadget is designed so that it may be used on either hand.

There are various possibilities with regard to the material that may be used to make the device. The material must be rigid so that it resists contact with sharp blades. Steel is preferred but the device could also be made with tungsten, titanium, and hard plastics such as High Density Polyethylene and Polypropylene, etc.

There are various possibilities with regard to the angle of the knuckle guard 100. The angle may vary in degree anywhere between 60 and 85 degrees, though 72 has been found to be the preferred angle. The device still functions properly with its intended use if the knuckle guard 100 is attached at any angle in the range listed.

There are various possibilities with regard to the base. The device will function properly with its intended use with a smooth base. The base may be pressed against the food to stabilize it. A textured bottom will provide greater stability for rounded foods such as carrots and potatoes, however. The bottom may be textured in any variety of pattern including, but not limited to, the use of tines 103, protruding grooves, or rounded numbs extending from the base. Tines 103 may work best for foods that are easily pierced to be held in place, such as carrots. The tines 103, if present, may be as few as 2 but the preferred embodiment is 4 tines 103. This provides a more evenly distributed area to accommodate foods that may need to be stabilized by the tines 103 but are not wide enough to be held in place with just 2. However, a completely textured bottom, using something such as grooves or nubs, will allow the user to stabilize harder to pierce, larger foods such as potatoes. A textured base may also allow the user to stabilize a portion of food to be cut that may not be wide enough to be held in place by tongs, for instance a bunch of herbs. Any texture, other than tines, to be used on the base would cover the entirety of the base, unlike tines which may be positioned at the back portion of the base of the gadget.

What is claimed is:

1. An apparatus comprising
A hollow chamber
A plate extending from the front side top of the chamber.

2. An apparatus as in claim 1 wherein said hollow chamber is rectangular in shape and closed on all sides and bottom.

3. An apparatus as in claim 1 wherein said hollow chamber has a textured bottom.

4. An apparatus as in claim 1 wherein said hollow chamber has holes on the backside to allow for air flow during use.

5. An apparatus an in claim 1 wherein said hollow chamber has tines attached to the bottom back side of the chamber.

6. An apparatus as in claim 1 wherein said chamber is made from a knife proof material including steel, a food grade plastic, tungsten, and titanium.

7. An apparatus for protecting hands while preparing food comprising
A chamber with an opening in the top for the user's fingers
A plate extending from the top of the chamber to cover the knuckles of the user.

8. An apparatus as in claim 7 wherein the chamber bottom has a texture capable of supporting and stabilizing food during preparation.
